(19) United States
(12) Patent Application Publication
(10) Pub. No.: US 2025/0390956 A1
(43) Pub. Date: Dec. 25, 2025

(54) METHOD AND APPARATUS FOR VERIFYING CURRENT INSURANCE AND PROVIDING VEHICLE INSURANCE QUOTES

(71) Applicant: AutoComplete Inc., San Francisco, CA (US)

(72) Inventors: Ahmed Khaishgi, San Francisco, CA (US); Jeffrey Pang, San Francisco, CA (US); Jonathan Zhang, Palos Verde Estates, CA (US)

(21) Appl. No.: 19/186,397

(22) Filed: Apr. 22, 2025

Related U.S. Application Data
(63) Continuation-in-part of application No. 18/201,722, filed on May 24, 2023, now abandoned.
(60) Provisional application No. 63/345,328, filed on May 24, 2022.

(51) Int. Cl. G06Q 40/08

(52) U.S. Cl. CPC G06Q 40/08

(57) ABSTRACT

The disclosure pertains to non-transitory computer-readable media collectively storing instructions that, when executed, cause one or more computers to perform a verification of a customer's insurance policy. The method entails receiving a trigger signal from a dealer software, wherein the dealer software stores identifying information for the customer who engaged in a triggering activity that generated the trigger signal; retrieving the customer's latest insurance policy from an external database based on the customer's identifying information; and upon receiving confirmation from the customer, outputting details of the customer's verified insurance policy.

### CROSS-REFERENCE TO RELATED APPLICATION(S)

This patent application is a Continuation-in-Part application claiming priority from U.S. patent application Ser. No. 18/201,722 filed on May 24, 2023, which in turn claims the benefit of U.S. Provisional Patent Application No. 63/345,328 filed on May 24, 2022. The contents of these applications are incorporated by reference herein.

### BACKGROUND

For many consumers, buying or leasing a car is simultaneously an exciting and a dreadful undertaking. While it is exciting to have a new vehicle, the process of shopping and negotiating for a car is daunting for many consumers. To make the automobile purchase process less painful for consumers, many solutions have been presented in the market. For example, there are fixed-price car sellers that offer no-haggle car purchase experience, taking the challenge of price negotiation out of the car-shopping equation. There are also private-party sales possibilities through websites where car owners list their cars for sale, so that customers do not have to work with car dealers to buy a car.

In spite of many efforts to simplify the vehicle acquisition process, the process as a whole is still far from simple. One of the reasons is that regardless of the channel used for purchase, purchasing a car usually also requires active insurance for the new automobile. Often, car sellers and dealers will not let a buyer drive off with a car unless some proof of insurance is provided. Dealers can collect an insurance card or ask customers for their insurance coverages, but there is no way to verify that the insurance policy is active or has the necessary asset coverages such as comprehensive or collision coverage to meet financing requirements. Furthermore, shopping for the right automobile insurance is another, separate process that is often cumbersome and time consuming. There are numerous insurance companies offering different rates and different packages, complicating the decision-making process for the car buyer. Contacting and obtaining insurance quotes from multiple carriers is time consuming. Sometimes, one insurance plan will be chosen initially to drive the car off the sales lot, then later changed to another insurance plan after some time and research has been done.

To take the pain out of the automobile acquisition process, an efficient method of finding the right automobile insurance is desired.

### SUMMARY

The disclosure pertains to one or more non-transitory computer-readable media collectively storing instructions that, when executed, cause one or more computers to perform a method of verifying a customer's insurance policy. The method entails receiving a triggering signal from a dealer software, wherein the dealer software stores identifying information for the customer who engaged in a triggering activity that generated the triggering signal, retrieving the customer's latest insurance policy from an external database based on the customer's identifying information, and upon receiving confirmation from the customer outputting details of the customer's verified insurance policy.

In one aspect, the disclosure pertains to a method of verifying a customer's insurance policy, the method including receiving a triggering signal from a dealer software, wherein the dealer software stores identifying information for a customer who engaged in a triggering activity that generated the triggering signal, retrieving the customer's latest insurance policy from an external database based on the customer's identifying information, and upon receiving confirmation from the customer, outputting details of the customer's verified insurance policy.

In another aspect, the disclosure pertains to a one-click insurance verification process whereby the confirmation above is received in the form of a click by the customer, and a time period from the confirmation to the outputting of details is no longer than 15 seconds.

### BRIEF DESCRIPTION OF THE DRAWINGS

FIG. 1A is a schematic depiction of an insurance data handler in accordance with one embodiment of the disclosure.

FIG. 1B is an enlarged view of the screenshots on the customer device from the bottom of FIG. 1A.

FIG. 2A, FIG. 2B, FIG. 2C, FIG. 2D, FIG. 2E, FIG. 2F, and FIG. 2G collectively depict a customer object management process executed by the insurance data handler in accordance with an embodiment of the disclosure.

FIG. 3A, FIG. 3B, and FIG. 3C depict an insurance selection process in accordance with embodiments of the disclosure.

FIG. 4A, FIG. 4B, and FIG. 4C are enlarged views of the screenshots on the customer device from FIG. 3B.

FIG. 5 depicts an insurance verification and quote generation process in accordance with an embodiment.

FIG. 6A and FIG. 6B depict examples of messages that a customer may receive at the start and at the conclusion of an insurance verification process, respectively.

FIG. 7 depicts examples of screens presented to customers to complete insurance verification in accordance with an embodiment.

FIG. 8 depicts an insurance verification process in accordance with an embodiment.

### DETAILED DESCRIPTION

This disclosure pertains to a simplified, painless way of verifying current insurance coverage of a customer and obtaining quotes from insurance carriers, thereby making the automobile acquisition process more pleasant as a whole. The system of the disclosure includes a processor, a memory, and a database that work with one another to execute instructions to access a plurality of external databases and external data sources, create customer objects using data pulled from the external data sources, communicate with insurance carriers to obtain quotes based on the customer objects, and present at least one of the quotes to a customer interface device. In one embodiment, the backend process runs on various Amazon Web Services (AWS) such as: EC2 for Ubuntu servers, RDS for Postgres databases, S3 for file storage. One or more non-transitory computer-readable media collectively storing instructions that, when executed, cause one or more computers, machines, processor or programmable circuitry to collectively perform the process described herein may be used.

As used herein, a “vehicle” may be any object that is used for transportation, available for rental, lease, or purchase, and is usually insured. A “dealer” may be any outfit or person that sells, rents, or leases vehicles, such as cars, trucks, planes, boats, etc. Although the examples herein are provided in the context of a customer shopping for an automobile at a car dealer, this is done for clarity of explanation and is not intended to be limiting.

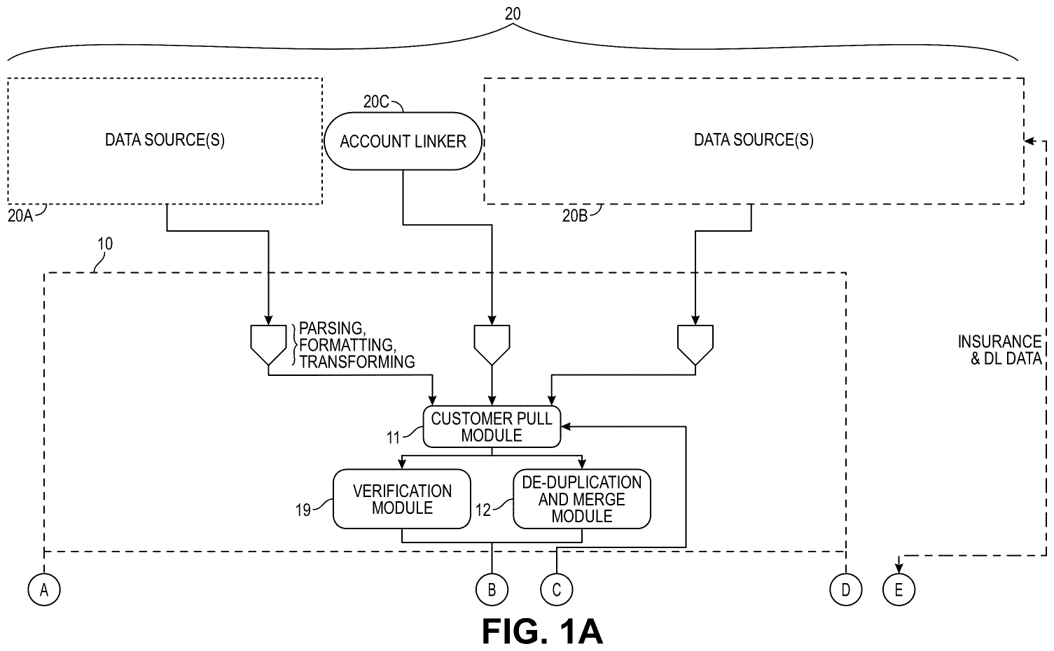

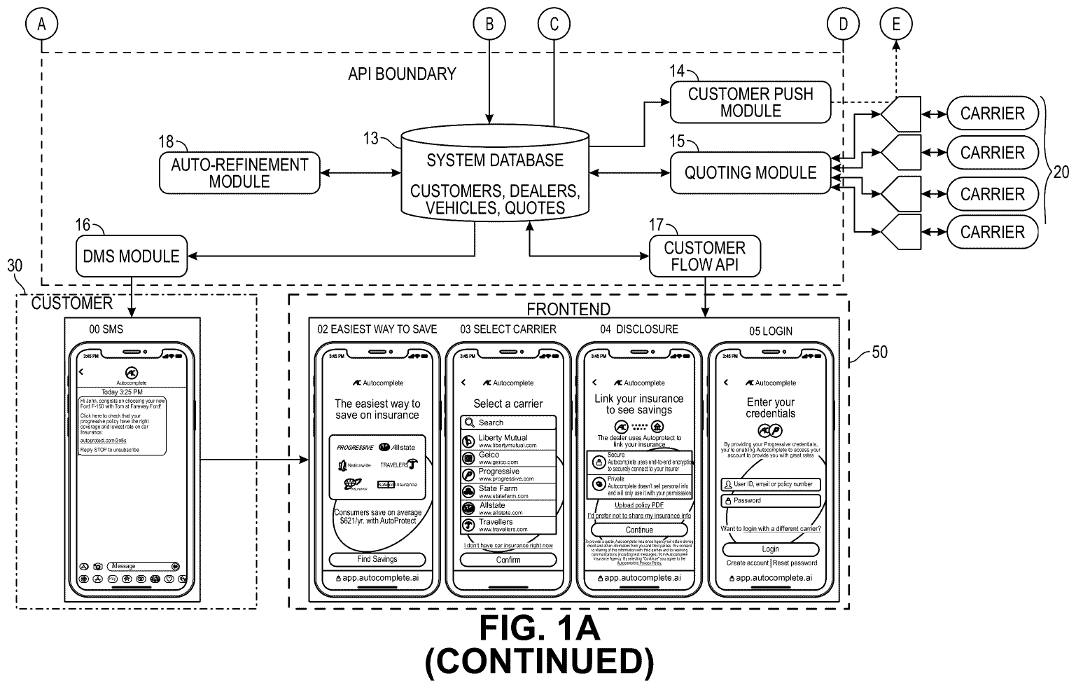

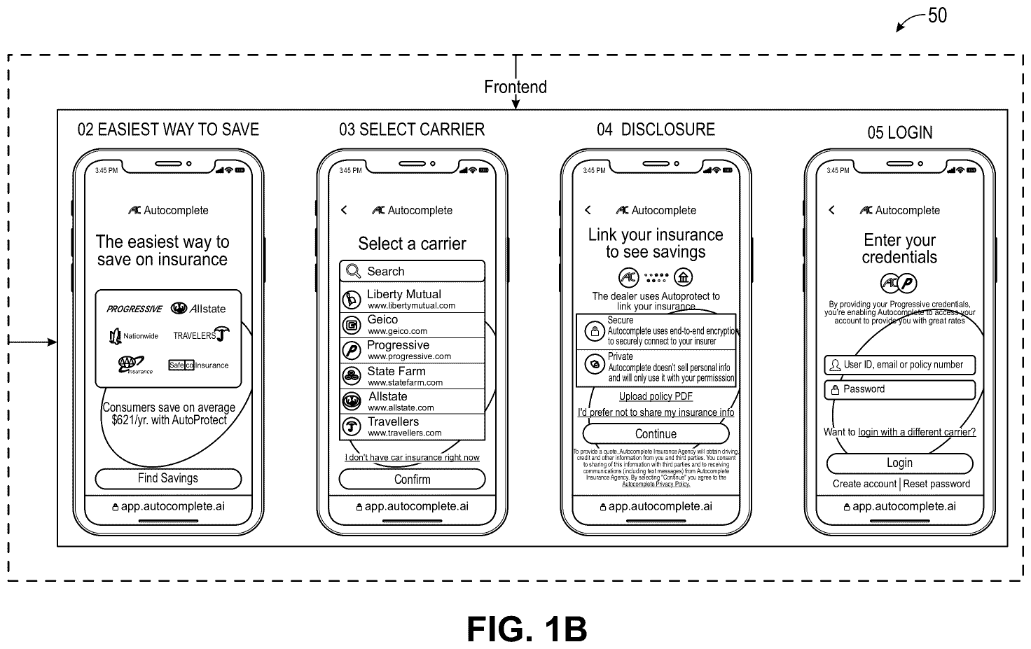

FIG. 1A depicts an insurance data handler 10 in accordance with one embodiment of the disclosure. In the embodiment that is depicted, the insurance data handler 10 is an Application Programming Interface (API) boundary that interfaces various external data sources 20 as well as customer devices 30 and insurance carriers 40 using any suitable communications network. The external data sources 20 may include one or more of third party data sources 20a such as data sources useful for data prefill function, insurance risk assessment databases, and personal records. The external data sources 20 may also include one or more software 20b used by automobile dealers (such as DM S platforms), and an account linker 20c such as Canopy Connect. The external data sources 20 provided herein are just examples, and not an exhaustive list or a required list of type of data sources interfaced by the insurance data handler 10. The external data sources 20 may be, but does not have to be, managed by a third party. Some external data sources 20 may contain publicly available general data; others may require permission from the customer to access.

The insurance data handler 10 interfaces various insurance carriers 40. As will be explained below, the insurance data handler 10 identifies a customer who is likely to be considering obtaining a new vehicle, automatically collects data regarding that customer that might affect her insurance policy and premium, and obtains quotes from various insurance carriers 40. Examples of the insurance carriers 40 include Quinstreet Rating Platform, Allstate, GEICO, Travelers, Safeco/Liberty, National General, Root, Bristol West, Mercury, Clearcover, MileAuto, Lemonade, Foremost, Elephant, Branch, and Progressive, among others.

On the frontend, the customer devices 30 interfaced by the insurance data handler 10 may be smartphones, tablets, computers (e.g., laptops), or any device that has a user interface and is able to connect to the network to communicate with the insurance data handler 10. The customer devices 30 may need to download an application and/or access a website.

The insurance data handler 10 includes a customer pull module 11 that interfaces and pulls data from the external data sources 20. The customer pull module 11 passes the collected data to a verification module 19 and a deduplication & merge module 12. The verification module 19 executes an insurance verification process 400. Generally, a customer who is leasing or purchasing a vehicle is required to have a certain level of insurance coverage before they can leave the dealer's lot with the new vehicle. It is important for the dealer to verify a customer's insurance before letting the customer leave with a new vehicle because the dealer could potentially be liable if the customer gets into an accident. Unfortunately, some customers provide inaccurate insurance information to the dealer, intentionally or unintentionally. The insurance verification process 400 of the disclosure provides a convenient and fast way for the dealer to check that the customer has a policy that is currently active, has certain type of coverage such as comprehensive and collision at certain deductibles. With the quick verification, insuring the newly purchased vehicle becomes a faster and simpler process.

The deduplication & merge module 12 may be used in conjunction with the verification module 19 to enhance accuracy of the information. The deduplication & merge module 12 processes the collected data to build a Customer Object for each customer, as will be explained in more detail below. A “customer object” is a set of predefined data fields that is filled out and submitted to insurance providers so the insurance providers can generate a quote. The processed data is then stored in the system database 13. The data in the system database 13 may be provided to external data sources 20, as the system database 13 aggregates the data pulled from external data sources 20, and might contain data that is not available in a specific one of the data sources 20. Some of the data sources 20 in FIG. 1A may be referred to as an “external database.” A quoting module 15 interfaces the insurance carriers 40. A dealer software module 16 (herein also referred to as “DMS module”) generates and transmits an introductory message to a customer. As will be explained in more detail below, the timing of the introductory message is customizable and determined by the vehicle dealer.

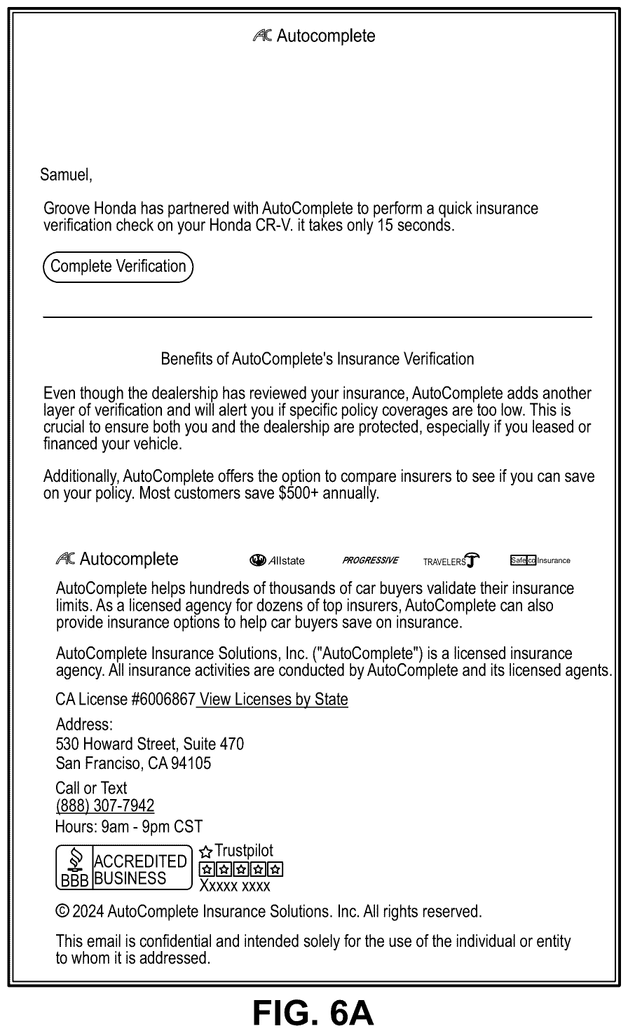

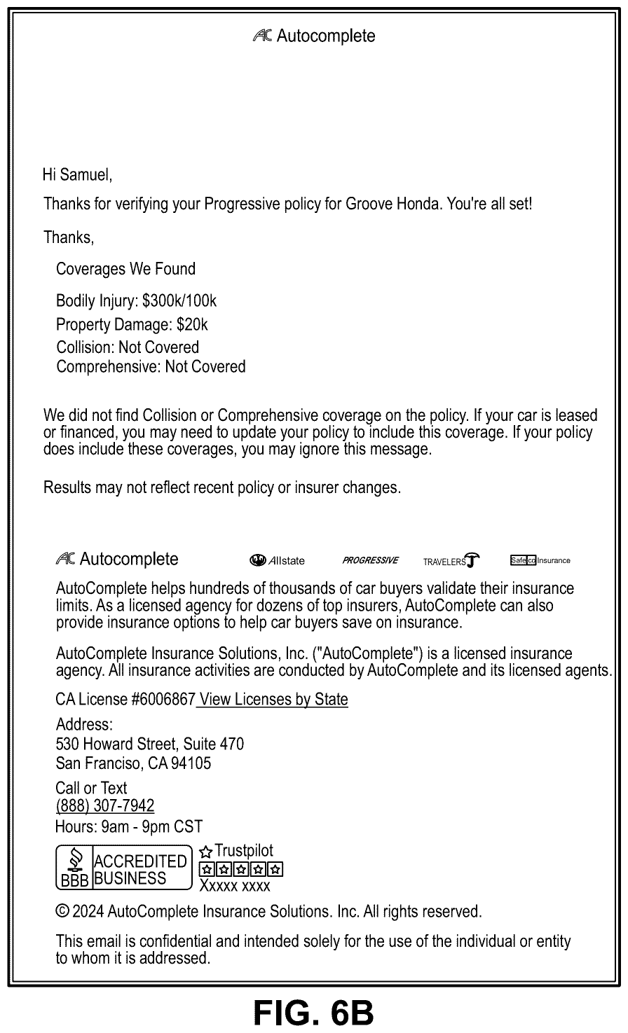

The introductory message generated by the DMS module 16 may be, for example, a text message or email with a hyperlink that may be opened if the customer is interested in interacting with the insurance data handler 10. In the example of FIG. 1A, the text message states the following:
FAREWEAY FORD: Erica, congrats on the Ford F-150!
We have one final step for your insurance verification. It takes 15 seconds through our partner AutoComplete's website. No further info is required.
Please finish this step at your earliest convenience: https://ac-insure.com/aScZMQ
Reply STOP to opt out
   In one embodiment, the introductory message is sent only upon receiving a trigger signal from the vehicle dealer. The trigger signal is generated, usually from the vehicle dealer, in response to a triggering activity such as an entry of a pending deal or a booked deal by the dealer into the data source 20b. The dealer has the customer's contact information such as phone number or email address, and can transmit the introductory message to the customer device 30. In response to the trigger signal from the dealer, the insurance data handler 10 presents the introductory message to the customer device 30, such as what is depicted in FIG. 6A. The customer may open the message, such as the one above, which may include a hyperlink.

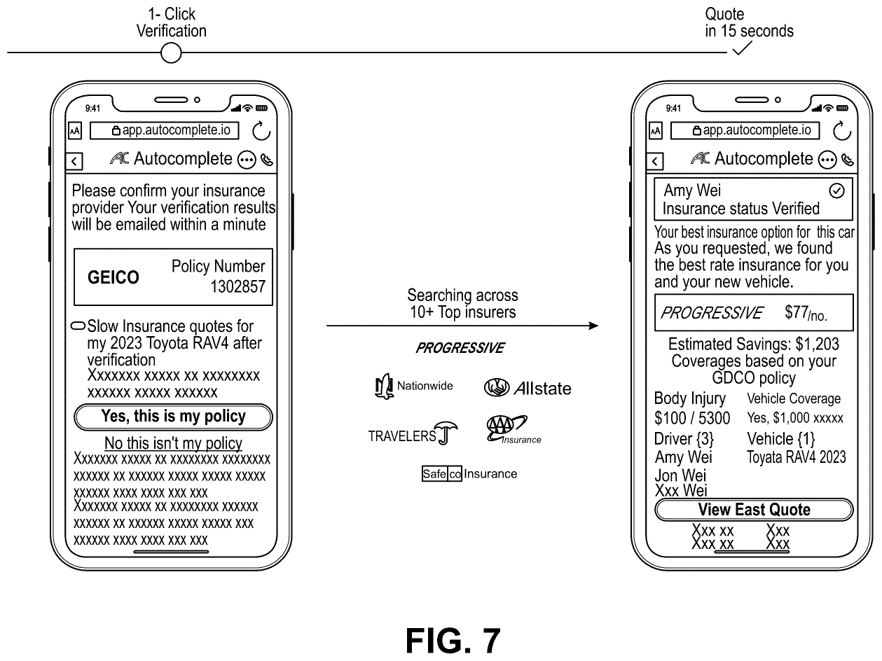

In some embodiments, the customer's activation of the hyperlink allows the data handler 10 to retrieve information about the customer's latest insurance policy from an external database 20, and present one piece of information about the policy as depicted on the lefthand side of FIG. 7. If the customer confirms that the presented piece of information matches his latest insurance policy, he may click on “Yes, this is my policy” button. This customer confirmation in the form of a single click triggers the verification process, as will be described in detail below. In some embodiments, this confirmation may also trigger the sharing of customer object to the insurance providers for quotes. Due to the efficient interaction between the quoting module 15 of the insurance data handler 10 and the insurance carriers 40 using accurately prefilled customer object, the customer may receive quotes in less than 30 seconds after she confirms the message. A “hyperlink,” as used herein, is a word or icon the customer can activate to interface with the insurance data handler 10.

Upon a customer's activation of the hyperlink that was sent by the DMS module 16 and a confirmation of the data by the customer, a customer flow API 17 interacts with the customer device 30 to move through the verification process, and the insurance selection and signup process. Screenshots 50 of an embodiment of what is presented on customer device 30 is depicted at the bottom of FIG. 1A. FIG. 1B depicts enlarged views of the screenshots 50 that may be presented to the customer device 30. As shown, the insurance data handler 10 is capable of obtaining quotes from numerous insurance carriers 40, and the customer is able to compare the quotes from the different carriers 40.

Optionally, the insurance data handler 10 may include an auto-refinement module 18 that includes an artificial intelligence program to automatically refine the logic for data authority from various data sources as well as the logic for accurately predicting the customer's information from those data sources 13. As used herein, “customer” includes both customers who end up signing up for an insurance through the insurance data handler 10 and shoppers who may be potential customers, with the understanding that not all customers who visit automobile dealers respond to the initial-contact correspondence and sign up with an insurance carrier through the insurance data handler 10. As used herein, “automatically” means without input, request, or command from a human user.

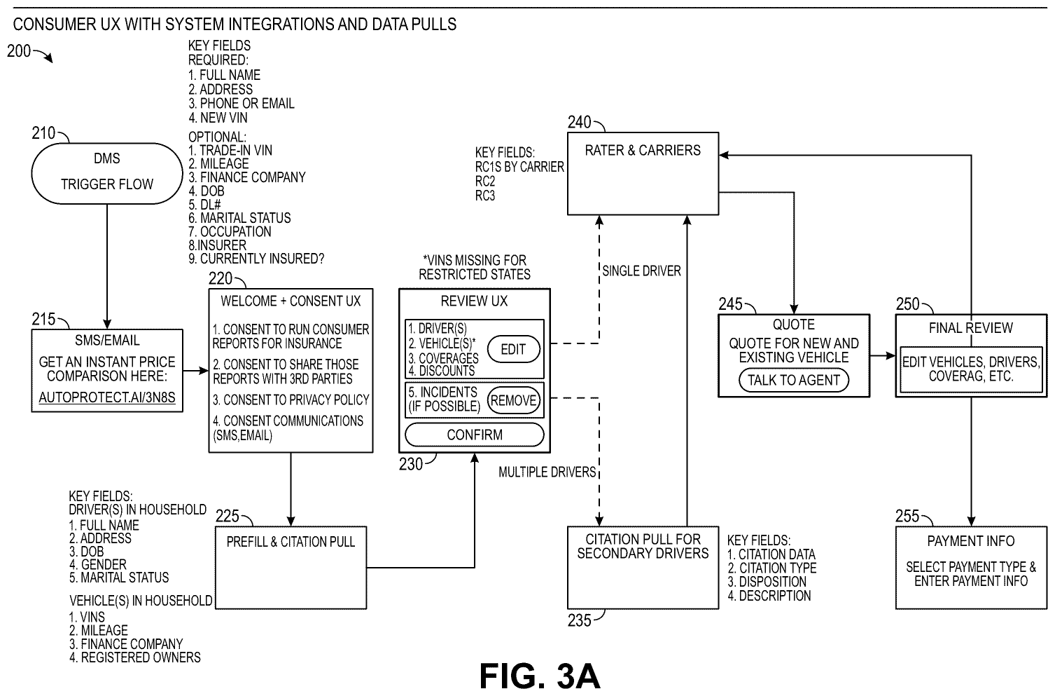

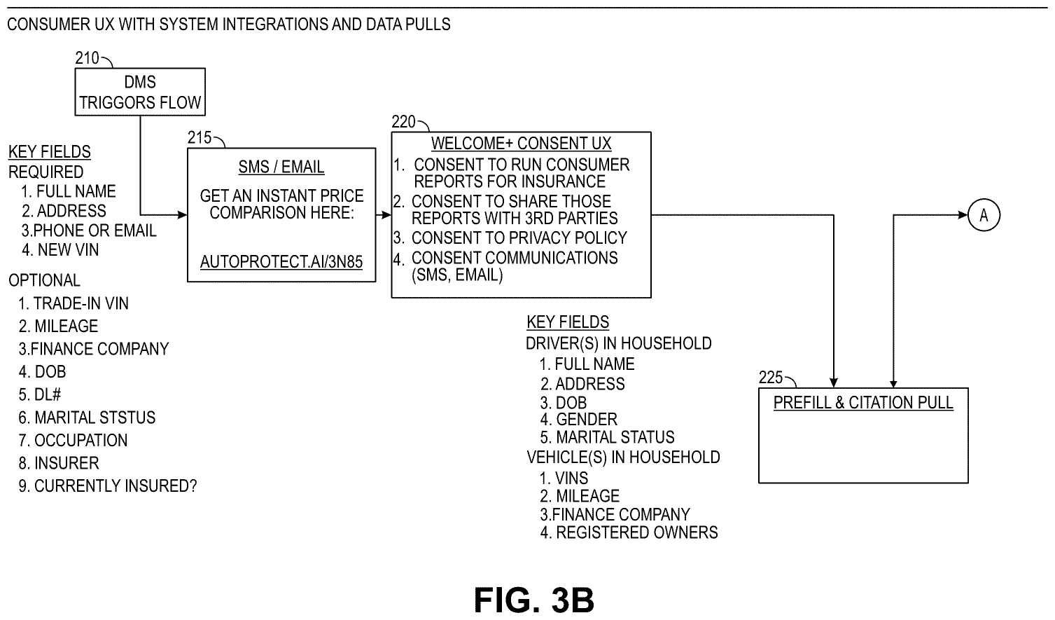

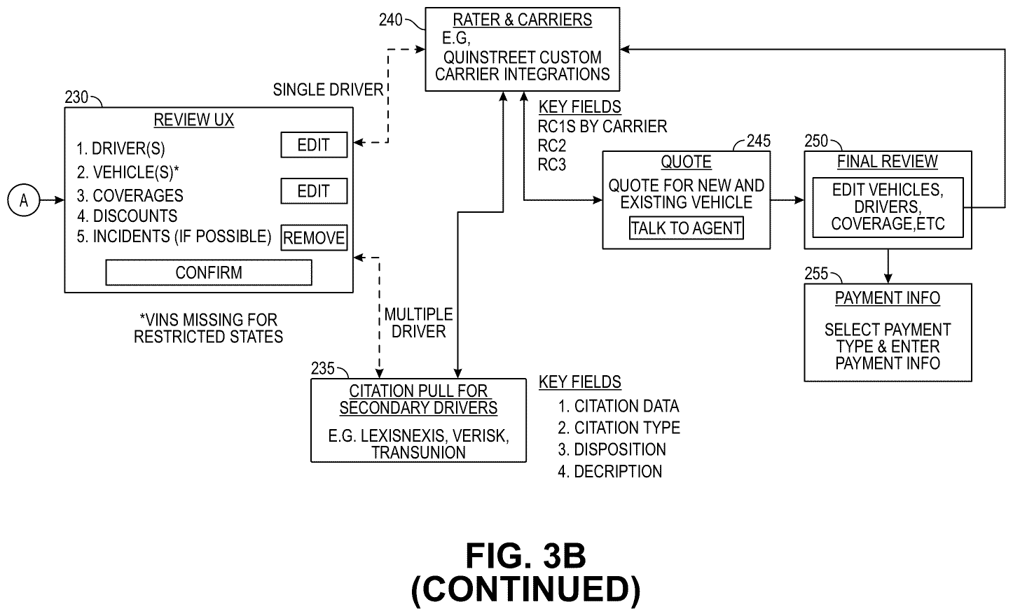

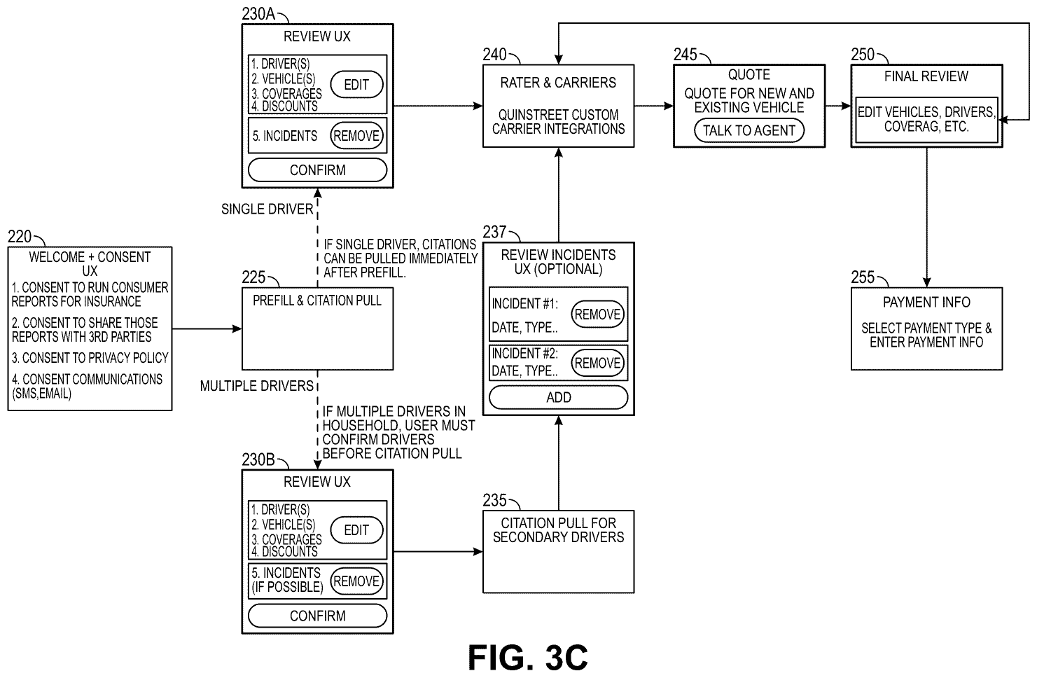

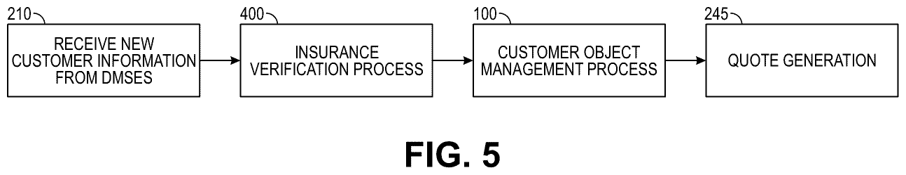

FIG. 5 depicts an overview of insurance verification and quote generation process in accordance with an embodiment. The insurance verification and quote generation process begins with a triggering activity in the external data source 20 (e.g., DM S Trigger 210 in FIG. 3A). The insurance data handler 10 periodically checks the data sources 20 where a triggering activity may happen. The frequency at which the external sources 20 are checked for a triggering activity may be adjustable (e.g., every hour, every 30 minutes, every 5 minutes, etc.). The triggering activity is linked with identifying information for the associated customer. For example, if the triggering activity is a pending deal input into a DMS, the DMS will also have one or more of a phone number, partial or entire social security number, name, and address of the customer.

The automatic insurance verification process 400 may happen based on the customer's identifying information. During the insurance verification process 400, a customer's insurance data, such as insurance history, is retrieved from external data sources 20 to verify the customer's identity and insurance coverage. During the insurance verification process 400, verification data from external sources 20 are retrieved and confirmation is requested from the customer that the data is accurate. Upon receiving the confirmation, a customer object management process 10 may be executed and a quote is generated 245, as described below.

FIG. 6A and FIG. 6B depict examples of messages that a customer may receive at the start and at the conclusion of an insurance verification process 400, respectively. An insurance verification process may be used in combination with the customer object management process 100 or the insurance signup process 200 described above. This insurance verification process relieves the customer of the burden of filling out a form or providing an insurance card to a dealer. A customer, upon selecting a vehicle to rent, lease, or purchase, may receive an email such as what is depicted in FIG. 6A. Although an email is used as an example, a similar message may be delivered using any known modes of communication, such as a text message. After seeing the message, the customer may activate the “Complete Verification” button to start the insurance verification process 400.

Upon receiving customer's selection on the “Complete Verification” button, the insurance data handler 10 may retrieve the customer's latest insurance policy to make sure the customer has adequate insurance coverage before driving the vehicle off the lot. After the verification process 400 is complete, a message with a verification summary such as what is depicted in FIG. 6B may be presented to the customer. The customer can then show or forward the message to the dealer as proof of insurance. If the insurance is inadequate, that will be visible in the verification summary. For example, in the example of FIG. 6B, if the dealer requires collision coverage, the dealer can refuse to let the customer drive off the new vehicle until collision coverage is verified. Although not explicitly shown, the policy information may include an expiration date, allowing the dealer to verify that the coverage is current. The insurance verification process 400 may be a standalone process. Optionally, the verification process 400 may be combined with the customer object management process 100 and an insurance quote generation process 245.

FIG. 7 depicts an embodiment in which the insurance verification process 400 is combined with an insurance quote generation process. In the embodiment of FIG. 7, the insurance data handler 10 may present a screen such as what is shown on the left-hand side, presenting what the insurance data handler 10 retrieved as the customer's latest insurance policy. As shown, the data handler 10 presents a piece of information pertaining to the customer's latest insurance policy that is retrieved. In the example depicted, the piece of information is the carrier information and policy number. The data handler 10 also requests confirmation based on the presented piece of information, that the information is correct for the customer's policy. The customer's one-lick confirmation “Yes, this is my policy” completes the verification process 400. All that is required from the customer to start the verification process is just one click. If the policy is expired, a notice may be presented to that effect. In some embodiments, the completion of the verification process 400, counting from the customer's “one click,” takes about 14-16 seconds in some embodiments, and no more than 15 seconds in some embodiments. In some embodiments, the completion of the verification process 400 may trigger an insurance search process that includes customer object management process 100, ultimately resulting in presentation of insurance quotes from carriers. In some embodiments, the customer object management process 100 follows the insurance verification process 400. Even with the insurance verification process 400 and the customer object management process 100, the amount of time it takes a customer to get a quote counting from the conclusion of the insurance verification process 400 is no more than 30 seconds, and may be as short as 15 seconds.

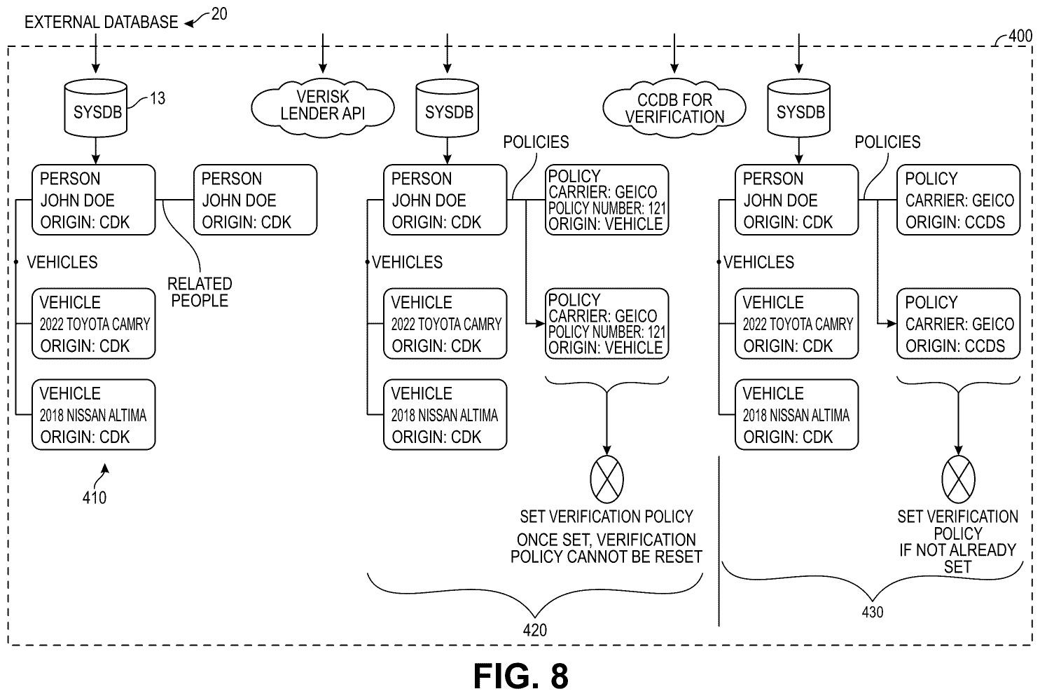

FIG. 8 depicts the insurance verification process 400 in accordance with an embodiment. No significant de-duplication or merging happens during the insurance verification process 400; data is simply retrieved and added to the system database 13. In process 410, identifying information for the customer is retrieved from an external database (e.g., DM S) and stored in the system database 13. In the embodiment of FIG. 8, the customer is identified as “John Doe,” related to “Jane Doe.” There are two vehicles under John Doe's policy: a 2022 Toyota Camry and a 2018 Nissan Altima. The database from where this customer data was retrieved is also identified in the records (e.g., as CDK in the example of FIG. 8).

Using the identifying information obtained in process 410, the system database 13 retrieves insurance policy information from an outside source, in process 420. In the example of FIG. 8, there are two policies under different numbers, both with GEICO, retrieved in process 420. This information may be presented to the customer, for example as the screen shown in FIG. 6B or on the left-hand side of FIG. 7. In the embodiment of FIG. 7, upon receiving confirmation from the customer, the verification process concludes. Optionally, another database may be queried for a second verification in process 430. In this case, the same request is submitted to a different external data source than in the process 420. If the retrieved data matches what was retrieved in process 420, for example by pulling up the same two policy numbers under GEICO, then verification process is complete.

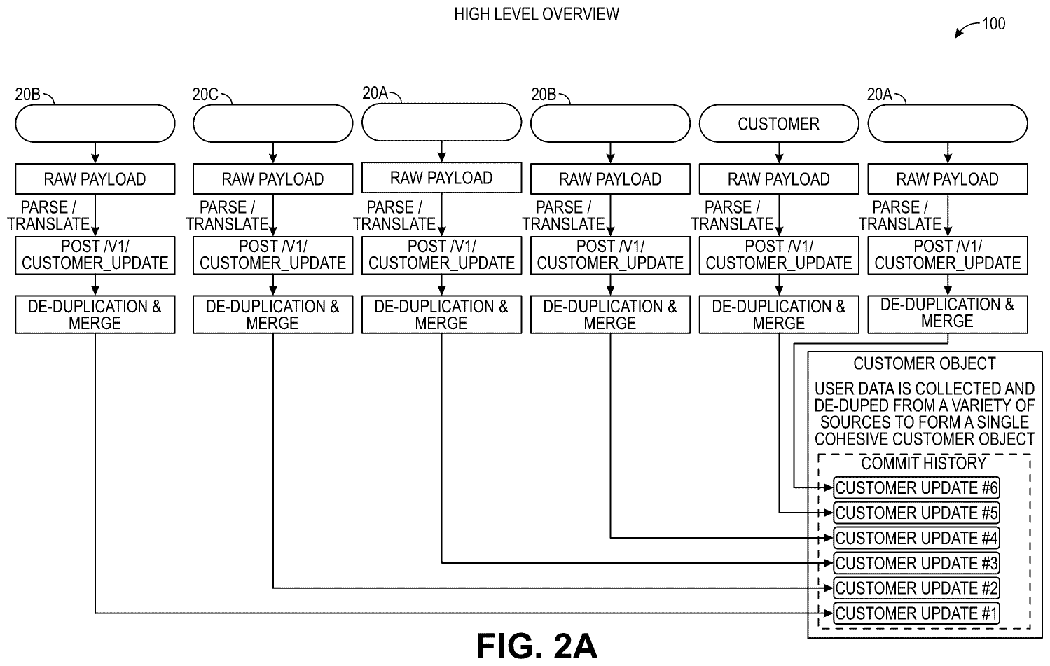

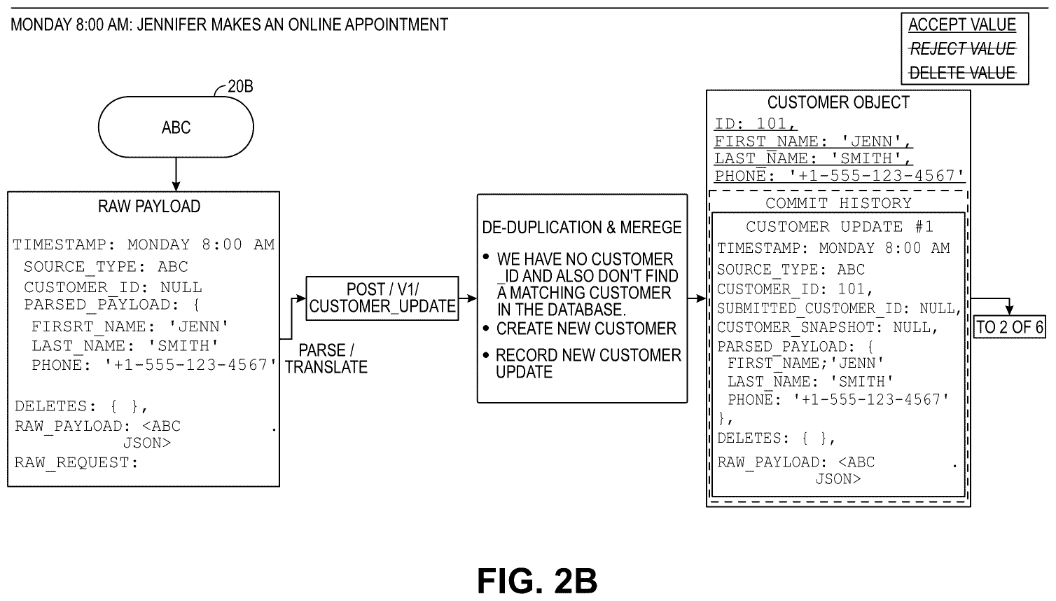

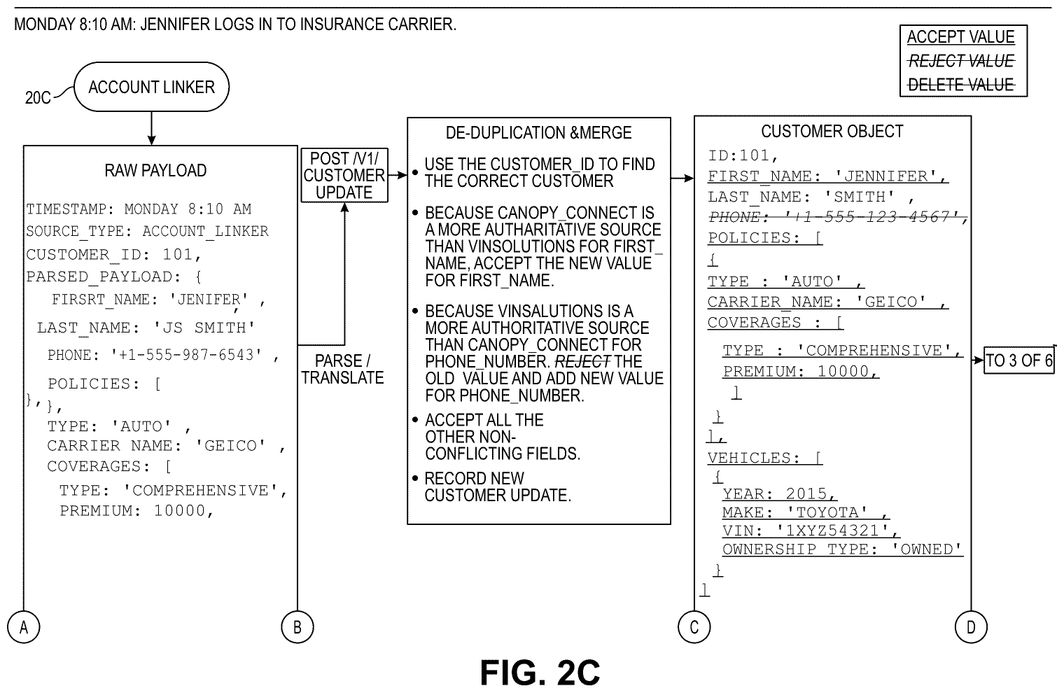

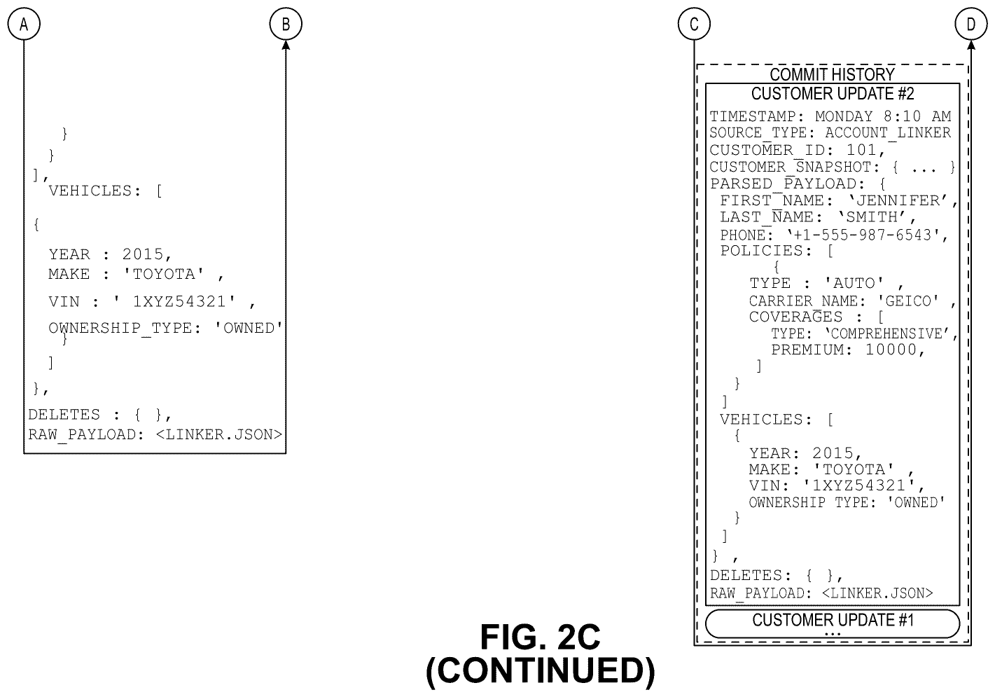

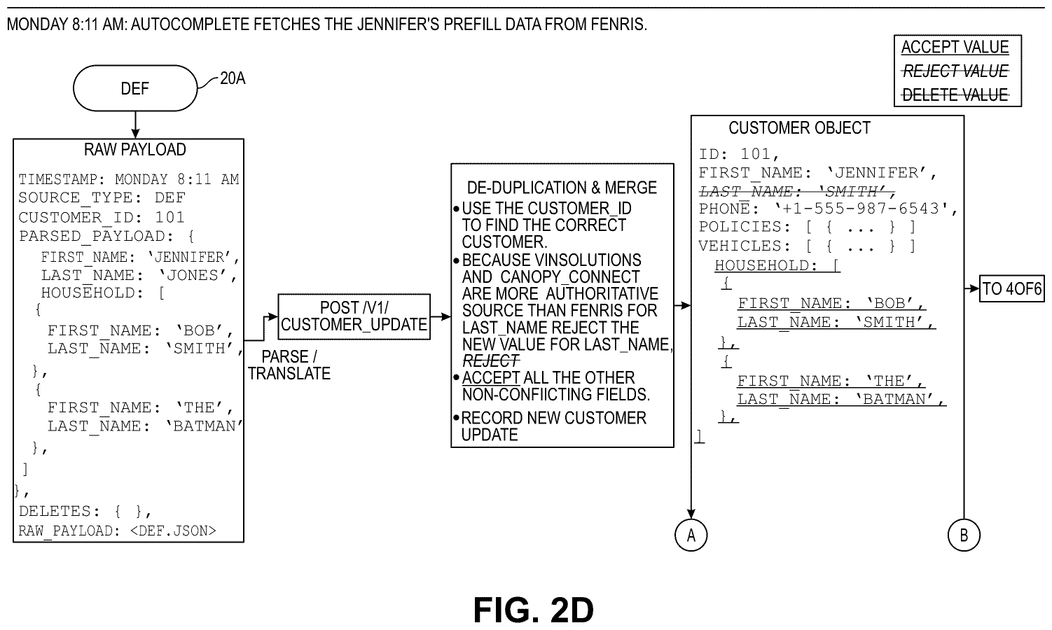

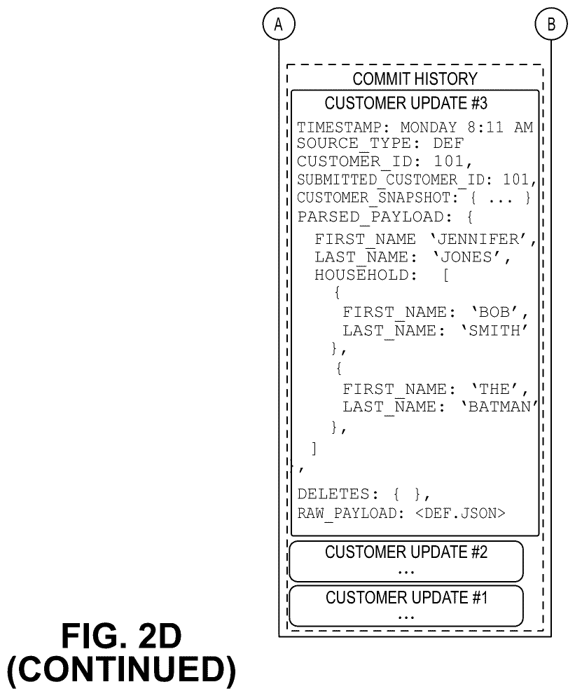

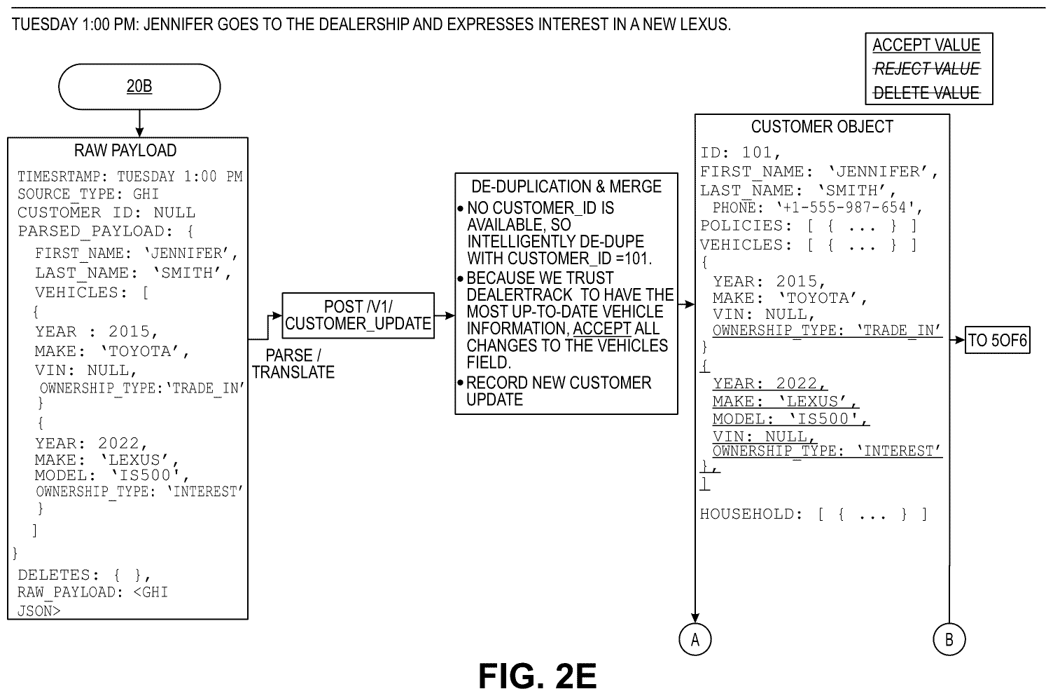

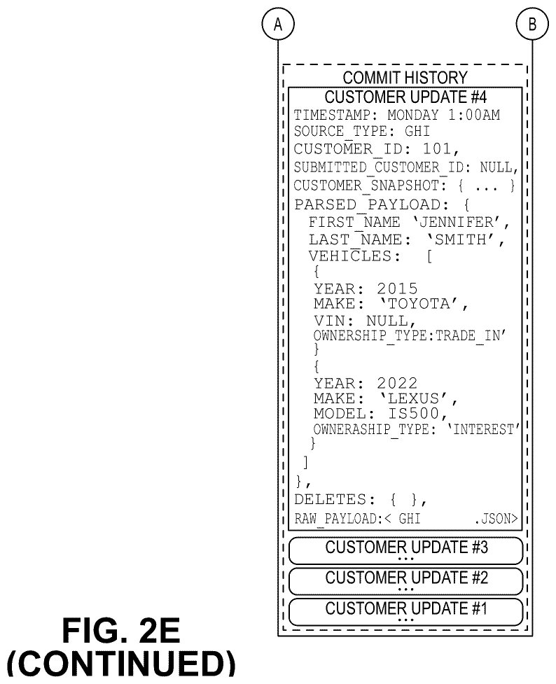

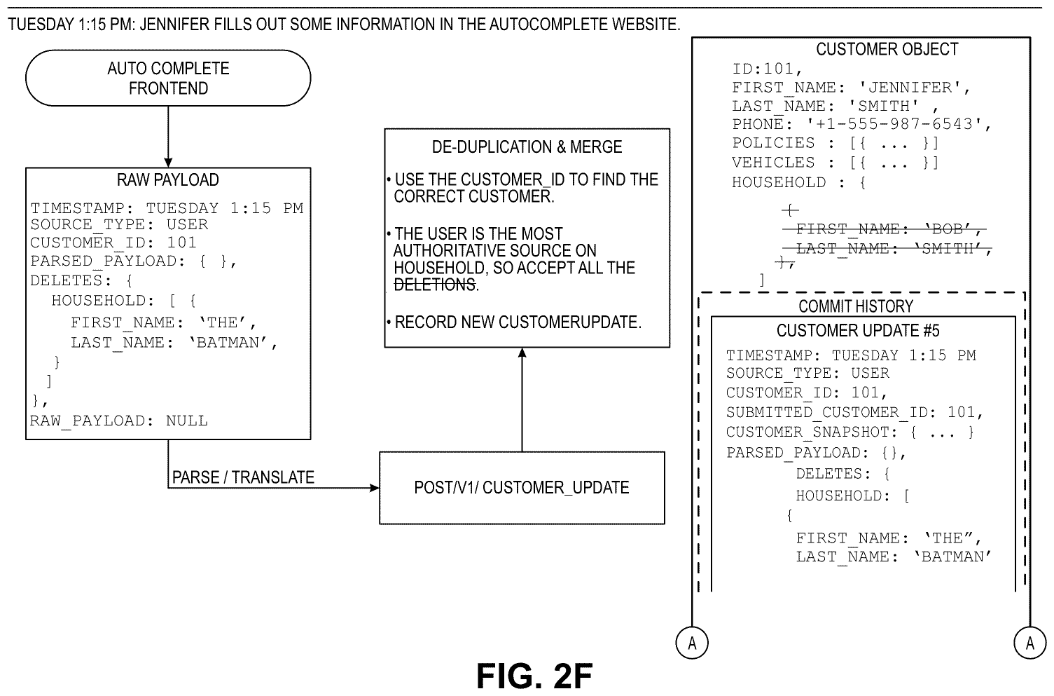

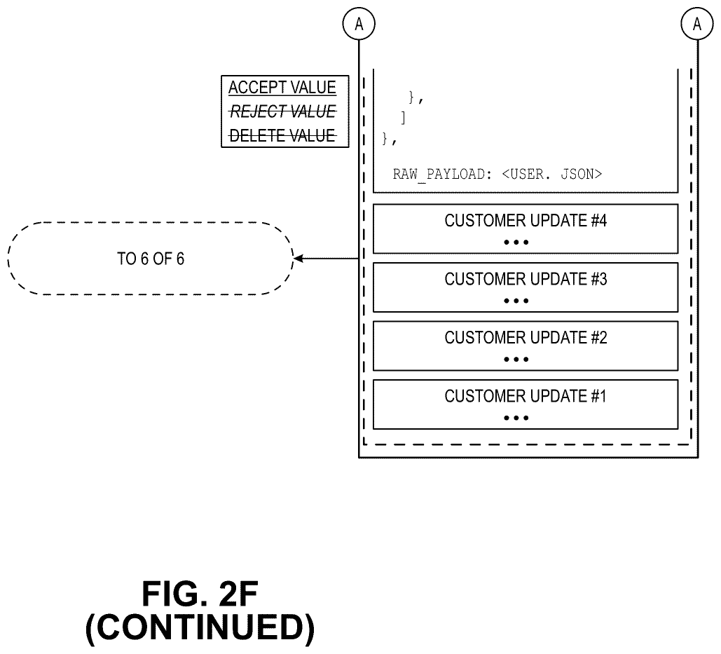

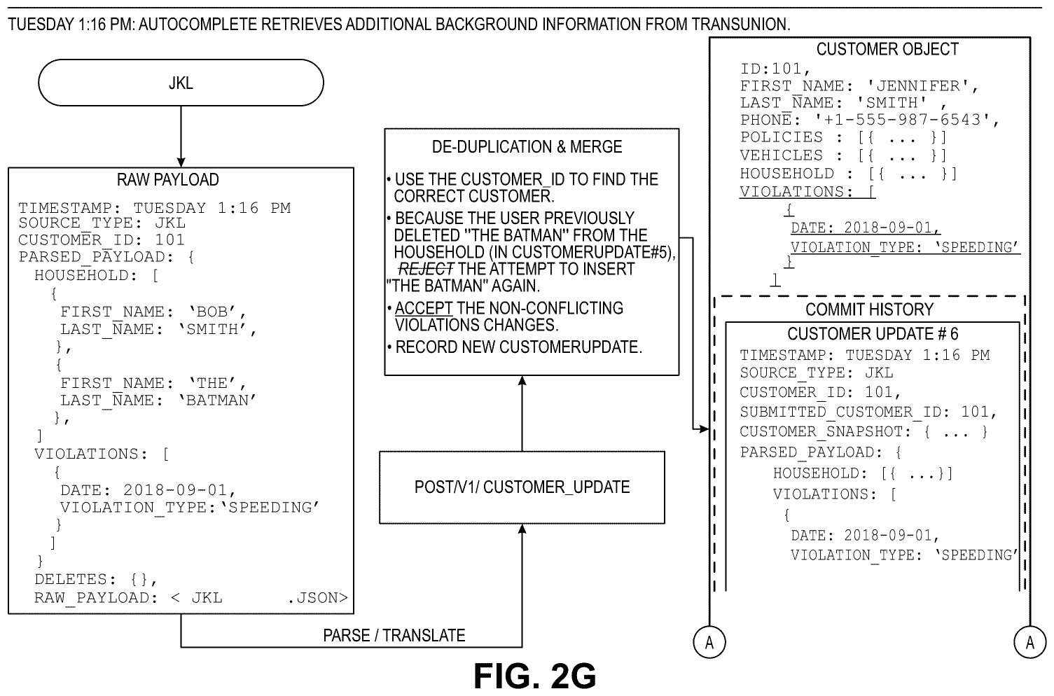

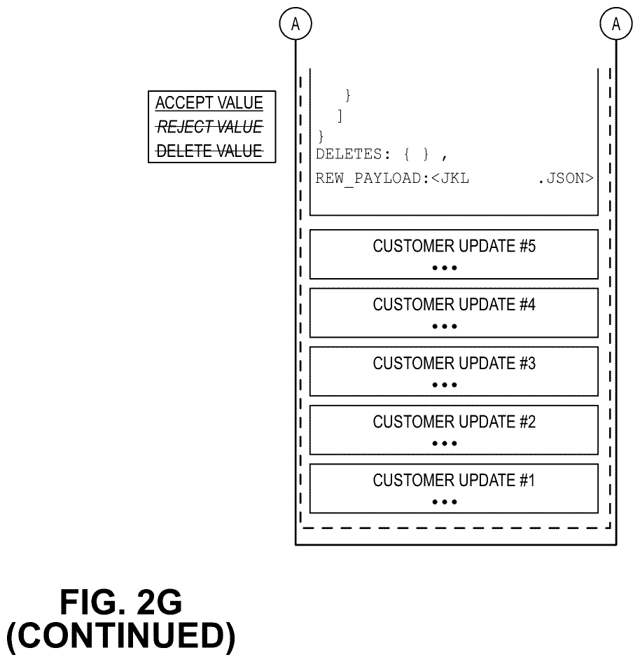

FIG. 2A depicts an overview of a customer object management process 100 as executed by an embodiment of the Customer De-duplication & Merge module 12. The customer object management process 100 may be, but does not have to be, used with the insurance verification process 400. Specifically, the customer object management process 100 is described herein with the assumption that the customer activated the hyperlink in the introductory message and gave the insurance data handler 10 permission to access the external data sources 20. As shown by the overview, each data set pulled from one of the external data sources 20 is processed by the De-duplication & Merge module 12 and stored in the system database 13 as a Customer Object update.

The example that is depicted in FIG. 2A, FIG. 2B, FIG. 2C, FIG. 2D, FIG. 2E, FIG. 2F and FIG. 2G is in the context of a customer named Jennifer, who performed a triggering activity (e.g., has a pending deal at a dealer). In this hypothetical situation, the triggering activity happened on Monday at 8:00 AM, when the pending deal was entered into the dealer's DMS platform (external database 20b) and was detected by the insurance data handler 10. The DM S platform may include basic customer data such as name and phone number, which the customer provided to the dealer. As shown in FIG. 2B, the time the data is pulled from the first data source ABC (one of external database 20b) is timestamped in the raw payload. In FIG. 2B, the raw payload retrieved from the first data source ABC includes the following data:
Customer_id: null
First name: ‘Jenn’
Last_name: ‘Smith’
Phone: +1-555-123-4567
   As this is the first piece of information pulled for this customer, there is no customr_id yet. A new Customer ID is created (101) and Customer Update #1 is stored in the Customer Object.

FIG. 2C depicts the customer object management process 100 that happens when the customer—in this case, Jennifer—logs in to her insurance carrier. If an account linker is used, the customer's logging in to the insurance carrier is detected through a second data source 20c, which may be an Account Linker such as Canopy Connect. The raw payload obtained from the second data source 20c, or an account linker, using the data that is available thus far shows the first name as “Jennifer” instead of “Jenn” as previously stored in Customer Update #1. The phone number is also different, shown as “+1-555-987-6543.” The second data source (account linker) has information that was not available from the Dealer Software 20b, such as information about types and amounts of the current insurance coverage this customer has. In the example that is depicted, Jennifer Smith is shown to have comprehensive auto insurance coverage under the carrier GEICO for a premium of $10,000. The vehicle that is covered is a 2015 Toyota having the VIN 1XYZ54321, and the car is owned.

Although not explicitly shown in FIG. 2A-FIG. 2G, there is a hierarchy of accuracy/authoritativeness for certain data fields among the different data sources 20. For example, the Dealer Software 20b that is used to record the pending deal might not be the most authoritative data source for a first name because people might use a nickname. If there is conflicting or mismatched data from two data sources, such as with the first name and phone number between the first data source A B C and the second data source Account Linker in this example, the insurance data handler 10 looks to the more authoritative source to update the Customer Object. In this case, the second data source is a more authoritative source than the first data source ABC for first name, so now the first name field is updated to “Jennifer.” If the first data source ABC is more authoritative than the second data source Account Linker for phone number, the first phone number is used as the correct phone number in the Customer Object. All other nonconflicting fields (such as the new data about the vehicle) are accepted, and the changes altogether are saved as Customer update #2.

FIG. 2D depicts the insurance data handler 10 accessing an external data source 20a, which in this case is a general database that includes household information. The name in this third database DEF comes up as “Jennifer Jones,” indicating a different last name than in the previous two data sources ABC and Account linker. An internal matching logic, which may reside in a processor that supports the insurance data handler 10, will be able to determine that the individual is a match and that the last name perhaps was a maiden name based on other matching information e.g. the address or household names. There are also additional names “Bob Smith” and “The Batman” associated with this customer_id as possible household members who may be covered under one policy. A gain, the insurance data handler 10 uses the more authoritative source for conflicting information. As the first data source ABC and the second data source Account Linker are rated more authoritative than the third data source DEF for last name field, the last name from the previous databases is maintained, and other nonconflicting data are added to create Customer Update #3. In the embodiment that is depicted, Customer Updates #1, #2, and #3 are all prefilled even before the appointment time.

FIG. 2E depicts the process that happens at the dealer. Jennifer is interested in a new Lexus, and the dealer enters, in its software, the new car data as follows:
Year: 2022
Make: Lexus
Model IS500
Ownership type: interest
   Jennifer's current car, 2015 Toyota, is marked as “trade-in.” As the Dealer software is trusted to have the most up to date data regarding vehicles (trade-in and of interest), those fields are updated using the Dealer software 20b, identified as fourth data source GHI, to create Customer Update #4.

FIG. 2F depicts the part of the customer object management process 100 where, after the customer signs the consent forms, is asked to provide additional data through a fifth data source, which might be the frontend customer device 30. Additional data request, in this example, is to verify that The Batman is part of the customer's household. The user has deleted Batman . . . so this is just user updating the data we've found. Jennifer responds by deleting The Batman as a household member, and the change is added to the Customer Object as Customer update #5.

FIG. 2G depicts the part of the customer object management process 100 where a sixth data source JKL is accessed for additional background information. In this example, the sixth data source JKL includes The Batman as a household member. A speeding violation by The Batman on Sep. 1, 2018 is on record. As The Batman was previously deleted from the household information associated with Jennifer (in Customer Update #5) and the customer input in FIG. 2F is considered a more authoritative source than the sixth data source JKL, The Batman may still be excluded in the final household update (Customer update #6). New information, such as driving violation record, is added to the update to be used for policy premium calculations by insurance carriers 40. After all the updates, the Customer Object should include a complete and accurate data that can be used by insurance carriers for quotations.

The de-duplication process depicted in FIGS. 2A-2G is just an example embodiment. Accurate auto-population of customer object results in dramatic time savings for a customer shopping for a vehicle and insurance. Assuming that Jennifer shows up at the dealer at the scheduled appointment time, the time it takes from the appointment time to the receiving of insurance quotes could be as short as 30 minutes. This length of time depends on factors like how long it takes Jennifer to finalize her decision about which car she is interested in, as the dealer would generate the trigger signal only when the vehicle is determined and confirmed to be available. Jennifer is spared from the tedium of having to fill out forms and provide the same basic information (address, gender, current carrier information, etc.) to different insurance carriers to obtain multiple quotes. A customer just reviews the message she receives and “clicks” on a confirmation “button” to obtain multiple quotes. The insurance carrier is spared from dealing with inaccurate information or human error and deception in the customer object. Accurate and efficient generation of customer object, powered by artificial intelligence, allows this frictionless, one-click shopping experience for vehicle insurance.

FIG. 3A, FIG. 3B, and FIG. 3C depict an insurance signup process 200 in accordance with an embodiment of the disclosure. FIG. 3A depicts one embodiment of the insurance signup process 200. FIG. 3B depicts the same insurance signup process 200 as FIG. 3A, and shows example screenshots on a user interface at different stages. Although the user interface is shown to be a smart phone, this is not a limitation of the disclosure. FIG. 3C depicts another embodiment of the insurance signup process 200.

In the embodiment depicted in FIG. 3A and FIG. 3B, the insurance selection process 200 is triggered when the vehicle of interest is determined and the dealer generates a trigger signal. The vehicle of interest is entered into the data source 20b, such as the dealer software (block 210). As described above, the entry of a vehicle of interest automatically triggers the CRM module 16 to generate and transmit an introductory message with a hyperlink (block 215). At this point, the Customer Object has already been partially created and updated through the process depicted in FIG. 2A through FIG. 2G. Hence, some or all of the following information is already available:
First name, last name
Residential address
Phone number
Email address
New VIN
Trade-in VIN
Mileage
Finance company
Date of birth
Driver's license number
Marital status
Occupation
Current insurer, if any

In block 220, the customer flow API 17 presents one or more consent forms to the customer device 30 asking for permission to access nonpublic data from data sources 20. Upon obtaining the permission, extra updates are made to the Customer Object (e.g., driving violations) in block 225, and a summary of the data is presented to the customer for verification (block 230). If there are additional drivers to be covered by the policy, citations are pulled for secondary driver(s) (block 235) and rates are obtained from different insurance carriers (block 240). The quoting module 15 shown in FIG. 1A interfaces the insurance carriers in block 240. A number of quotes may be received, including one from the current insurance carrier. Based on a comparison, the carrier offering the best rate for comparable coverage may be presented in block 245, as shown by the corresponding screenshot in FIG. 3B. The customer may explore other options or see how changing the coverage terms affects the rates in the final review stage in block 250. At the end of the exploration, she may choose a plan and submit payment information in block 255.

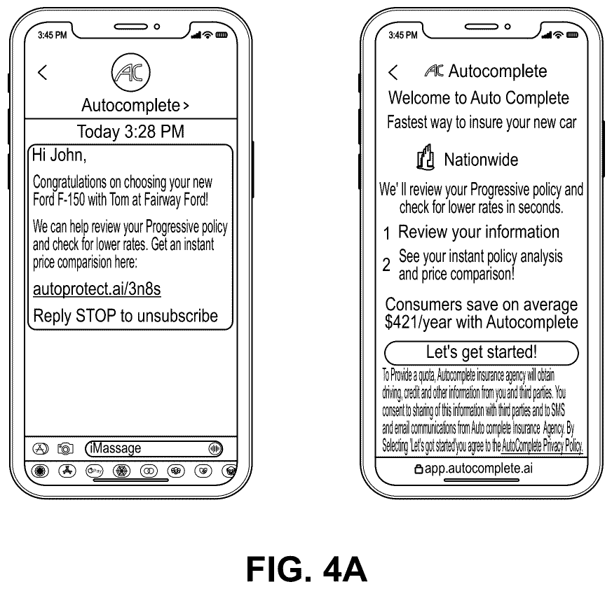

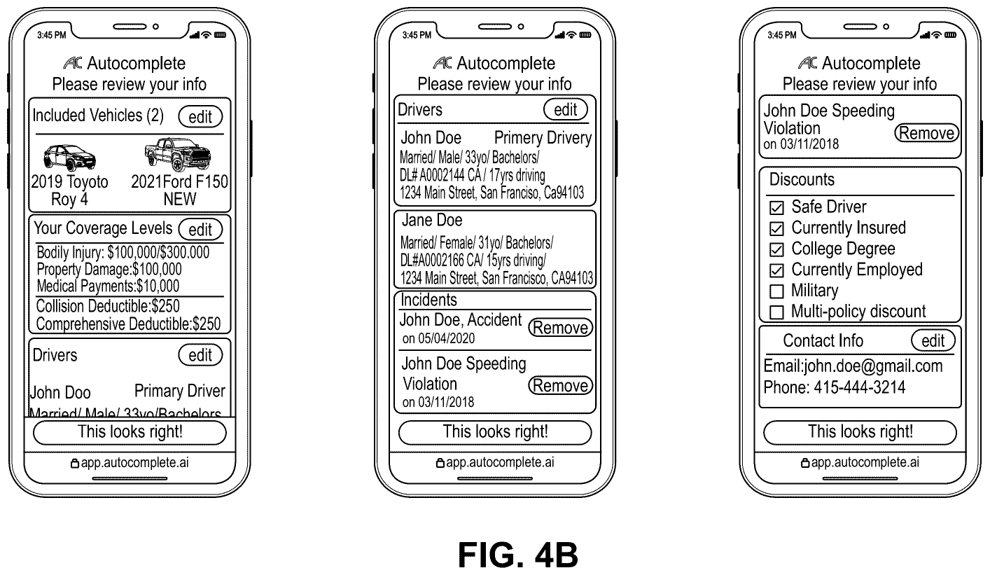

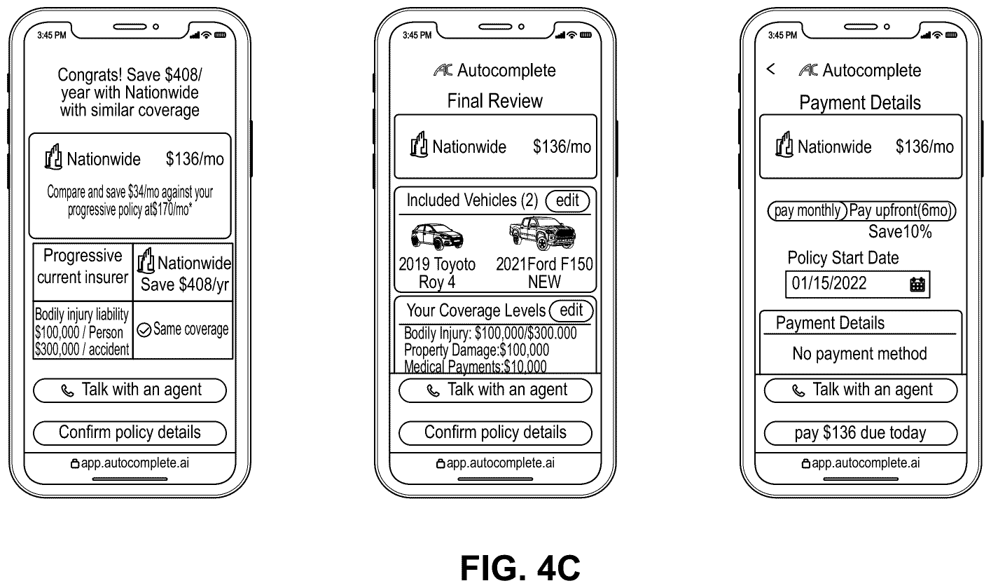

As mentioned above, FIG. 3B depicts the screenshots that would be presented on the customer device 30 for each stage described at the top of FIG. 3B. Screenshots 4A, which may be displayed on the customer device in blocks 215 and 220, are shown enlarged in FIG. 4A. In this particular example, the customer currently has a policy with Nationwide, and is asked to provide consent to share insurance reports with other providers for obtaining quotes. Screenshots 4B display the data that have been pulled from external data sources 20 and aggregated using the process described above, seek review and input from the customer. In screenshots 4C, best quote is presented to the customer device and payment details are requested.

The alternative version of the insurance selection process 200 depicted in FIG. 3C and bottom of FIG. 3B include similar steps as the process depicted in FIG. 3A and top of FIG. 3B, except that when there is more than one driver to be covered under a plan, the customer is asked to confirm drivers before driving record is pulled for each additional driver (block 230b, as opposed to block 230a for single driver). Only after the customer confirms the list of drivers to be covered does the customer pull module 11 access the data for the secondary drivers (block 235). Then, the customer is presented with an opportunity to review the incidents for secondary drivers in block 237. This review process may or may not be part of the process in FIG. 3A. After the incident review is completed in block 237, insurance carriers 40 are contacted in block 240, quotes are obtained (block 245), customer reviews the options (block 250), and a selection is made and payment information is provided (block 255). The customer review process 230a/230b/237 is used to improve accuracy of data by cross-checking data across multiple sources (including the customer) and making sure that the final data on which the quote will be based is consistent across all sources. For example, if, in step 237, the customer dishonestly deletes an incident that actually happened to get a lower rate, the quote will question the input because it will be inconsistent with the carrier's reports.

While the embodiments are described in terms of a method or technique, it should be understood that the disclosure may also cover an article of manufacture that includes a non-transitory computer readable medium on which computer-readable instructions for carrying out embodiments of the method are stored. The computer readable medium may include, for example, semiconductor, magnetic, opto-magnetic, optical, or other forms of computer readable medium for storing computer readable code. Further, the disclosure may also cover apparatuses for practicing embodiments of the inventive concept disclosed herein. Such apparatus may include circuits, dedicated and/or programmable, to carry out operations pertaining to embodiments. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to the embodiments.

The embodiments were chosen and described in order to best explain the inventive concept and its practical applications, to thereby enable others skilled in the art to best utilize the inventive concept and various embodiments with various modifications as are suited to the particular use contemplated. Also, individual features of any of the various embodiments or configurations described above can be mixed and matched in any manner, to create further embodiments contemplated by the inventive concept.

What is claimed is:

1. One or more non-transitory computer-readable media collectively storing instructions that, when executed, cause one or more computers to perform a method of verifying a customer's insurance policy, the method comprising:
receiving a trigger signal from a dealer software, wherein the dealer software stores identifying information for the customer who engaged in a triggering activity that generated the trigger signal;
based on the customer's identifying information, retrieving the customer's latest insurance policy from an external database; and
after receiving confirmation from the customer, outputting details of the customer's verified insurance policy.

2. One or more non-transitory computer-readable media of claim 1, wherein a time period from the receiving of confirmation to the outputting of details is no longer than 15 seconds.

3. One or more non-transitory computer-readable media of claim 1, wherein the details of the customer's verified insurance policy comprise date of expiration, types of coverage, and amounts of coverage.

4. One or more non-transitory computer-readable media of claim 1, further comprising:
creating a customer object that includes information from external data sources, wherein the information is useful for generating an insurance quote;
sharing the information in the customer object with one or more insurance providers to obtain insurance quotes for a vehicle; and
receiving one or more insurance quotes in less than 30 seconds from the sharing.

5. The one or more non-transitory computer-readable media of claim 4, wherein the creating of the customer object comprises accessing multiple external data sources and aggregating data from the multiple external data sources.

6. The one or more non-transitory computer-readable media of claim 5, wherein the aggregating of the data comprises resolving inconsistency in data based on a predefined hierarchy of data authoritativeness.

7. The one or more non-transitory computer-readable media of claim 6, wherein the predefined hierarchy of data authoritativeness is based on ranking the external data sources by estimated accuracy for each field.

8. The one or more non-transitory computer-readable media of claim 7, wherein the predefined hierarchy of data authoritativeness is field-dependent.

9. The one or more non-transitory computer-readable media of claim 6, further comprising presenting a message on the customer device requesting permission to access nonpublic data regarding the customer prior to the sharing.

10. The one or more non-transitory computer-readable media of claim 1, further comprising:
transmitting a verification request button to a device associated with the customer; and
detecting an activation of the verification request button before retrieving the customer's latest insurance policy.

11. The one or more non-transitory computer-readable media of claim 1, wherein the confirmation from the customer comprises confirmation that a piece of information about the customer's latest insurance policy that is retrieved from the external database and presented to the customer is correct.

12. A computer-implemented method of verifying a customer's insurance policy, comprising:
receiving a trigger signal from a dealer software, wherein the dealer software stores identifying information for a customer who engaged in a triggering activity that generated the trigger signal;
based on the customer's identifying information, retrieving the customer's latest insurance policy from an external database; and
upon receiving confirmation from the customer, outputting details of the customer's verified insurance policy.

13. The computer-implemented method of claim 12, wherein a time period from the receiving of confirmation to the outputting of details is no longer than 15 seconds.

14. The computer-implemented method of claim 12, wherein the details of the customer's verified insurance policy comprise date of expiration, types of coverage, and amounts of coverage.

15. The computer-implemented method of claim 12, further comprising presenting a piece of information about the customer's latest insurance policy that is retrieved from the external database to the customer, and requesting confirmation that the piece of information is correct.

16. The computer-implemented method of claim 12, wherein the confirmation is one click by the customer.

17. The computer-implemented method of claim 12, further comprising:
creating a customer object that includes information retrieved from external data sources, wherein the information is useful for generating an insurance quote;
sharing the information in the customer object with one or more insurance providers to obtain an insurance quote for a vehicle; and
receiving one or more insurance quotes in less than 30 seconds from the sharing.

18. The computer-implemented method of claim 17, wherein the creating of the customer object comprises accessing multiple external data sources and aggregating data from the multiple external data sources.

19. The computer-implemented method of claim 18, wherein the aggregating of the data comprises resolving inconsistency in data based on a predefined hierarchy of data authoritativeness.

20. The computer-implemented method of claim 19, wherein the predefined hierarchy of data authoritativeness is dependent on type of information.
